(19) United States
(12) Patent Application Publication
(10) Pub. No.: US 2010/0186415 A1
(43) Pub. Date: Jul. 29, 2010

(54) TURBULATED AFT-END LINER ASSEMBLY AND RELATED COOLING METHOD

(75) Inventors: Jerome D. BROWN, Simpsonville, SC (US); Mert Berkman, Greenville, SC (US); Stephen Kent Fulcher, Greenville, SC (US); Andre Smith, Simpsonville, SC (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 12/358,694

(22) Filed: Jan. 23, 2009

(51) Int. Cl. F02C 1/00

(52) U.S. Cl. 60/755

(57) ABSTRACT

In a combustor for a turbine a cover sleeve is disposed between the aft end portion of the combustor liner and a resilient seal structure to define an air flow passage therebetween. The cover sleeve has at a forward end thereof a plurality of air inlet feed holes for directing cooling air into the air flow passage. A radially outer surface of the combustor liner aft end portion defining the air flow passage includes a plurality of turbulators projecting towards but spaced from the cover sleeve and a plurality of supports extending to and engaging the cover sleeve to space the cover sleeve from the turbulators to define the air flow passage.

### BACKGROUND OF THE INVENTION

This invention relates to internal cooling within a gas turbine engine; and more particularly, to an assembly and method for providing better and more uniform cooling in a transition region between a combustor liner and a transition duct that directs combustion gases to the first stage of the turbine.

Traditional gas turbine combustors use diffusion (i.e., non-premixed) combustion in which fuel and air enter the combustion chamber separately. The process of mixing and burning produces flame temperatures exceeding 3900° F. Since conventional combustor liners and/or transition pieces are generally capable of withstanding a maximum temperature of only about 1500° F. (about 820° C.) for about ten thousand hours (10,000 hrs), steps to protect the combustor liner and/or transition duct, as well as the seal construction at the interface of the combustor liner and transition piece, must be taken for durability, creep resistance and seal integrity. This has typically been done by film-cooling which involves introducing relatively cool compressor air into a plenum formed by the combustor liner surrounding the outside of the combustor. In this prior arrangement, the air from the plenum passes through louvers in the combustor liner and then passes as a film over the inner surface of the liner, thereby maintaining combustor liner integrity.

Because diatomic nitrogen rapidly disassociates at temperatures exceeding about 3000° F. (about 1650° C.), the high temperatures of diffusion combustion result in relatively large NOx emissions. One approach to reducing NOx emissions has been to premix the maximum possible amount of compressor air with fuel. The resulting lean premixed combustion produces cooler flame temperatures and thus lower NOx emissions. NOx emissions reduction through premixed combustion is limited by the fraction of total compressor air available for combustion. Although lean premixed combustion is cooler than diffusion combustion, the flame temperature is still too hot for prior conventional combustor components to withstand.

Furthermore, because the advanced combustors premix the maximum possible amount of air with the fuel for NOx reduction, little or no cooling air is available, making film-cooling of the combustor liner and transition piece impractical. Nevertheless, combustor liners require active cooling to maintain material temperatures below limits. In dry low NOx (DLN) emission systems, this cooling can only be supplied as cold side convection. Such cooling must be performed within the requirements of thermal gradients and pressure loss. Thus, means such as thermal barrier coatings in conjunction with “backside” cooling have been considered to protect the combustor liner and transition piece from damage by such high heat. Backside cooling involved passing the compressor discharge air over the outer surface of the transition piece and combustor liner prior to premixing the air with the fuel.

Another current practice is to impingement cool the liner, and, optionally, to provide turbulators on the exterior surface of the liner (see, for example, U.S. Pat. No. 7,010,921). Still another practice is to provide an array of concavities on the exterior or outside surface of the liner (see U.S. Pat. No. 6,098,397). These various known techniques enhance heat transfer but with varying effects on thermal gradients and pressure losses.

Another technique, as described in commonly owned U.S. Pat. No. 7,010,921, provides straight axial cooling air channels, radially between the liner and the seal at the aft end of the liner, designed especially to cool the seal.

There remains a need, however to provide even more effective cooling in the combustor liner/transition piece interface region to further increase the durability and hence useful life of the combustor liners and associated seals.

### BRIEF DESCRIPTION OF THE INVENTION

The above discussed and other drawbacks and deficiencies are at least partially overcome or alleviated in an example embodiment by an apparatus for cooling the interface region between the combustor liner and the transition piece of a gas turbine.

Thus, in one aspect, the invention relates to a combustor liner comprising an open-ended, generally cylindrical body having a forward end and an aft end, the aft end formed with a plurality of axially extending channels defined by a plurality of axially extending, circumferentially spaced ribs; each channel provided with a plurality of axially-spaced transverse turbulators, the ribs having a height greater than the turbulators.

In another aspect, the invention relates to a combustor for a turbine comprising: a combustor liner; a first flow sleeve surrounding the combustor liner with a first flow annulus therebetween, the first flow sleeve having a plurality of cooling apertures formed about a circumference thereof for directing compressor discharge air into the first flow annulus; a transition piece body connected to the combustor liner, the transition piece body being adapted to carry hot combustion gases to the turbine; a second flow sleeve surrounding the transition piece body, the second flow sleeve having a second plurality of cooling apertures for directing compressor discharge air into a second flow annulus between the second flow sleeve and the transition piece body, the first flow annulus connecting to the second flow annulus; a resilient seal structure disposed radially between an aft end portion of the combustor liner and a forward end portion of the transition piece body; a cover sleeve disposed radially between the aft end portion of the combustor liner and the resilient seal structure, a plurality of axially-extending, circumferentially-spaced air flow channels between the cover sleeve and the aft end portion of the combustor liner; and a plurality of axially-spaced, transversely-oriented turbulators in each of the air flow channels, projecting towards but spaced from the cover sleeve.

In still another embodiment, the invention relates to a method of cooling a transition region in a gas turbine combustor between an aft end portion of a combustor liner and a forward end portion of a transition piece, the combustor liner having a first flow sleeve surrounding the combustor liner with a first flow annulus therebetween, the first flow sleeve having a first plurality of cooling apertures formed about a circumference thereof for directing compressor discharge air into the first flow annulus, the transition piece connected to the combustor liner and adapted to carry hot combustion gases to the turbine; a second flow sleeve surrounding the transition piece, the second flow sleeve having a second plurality of cooling apertures for directing compressor discharge air into a second flow annulus between the second flow sleeve and the transition piece, the first flow annulus connecting to the second flow annulus; the transition region including a resilient seal structure disposed radially between the aft end portion of the combustor liner and the forward end portion of the transition piece; the method comprising: (a) configuring the aft end portion of the combustor liner to include a plurality of axially oriented flow channels, and a plurality of radially outwardly projecting, transverse turbulators in each of the flow channels; (b) disposing a cover sleeve between the aft end portion of the combustor liner and the resilient seal structure so as to close a radially outer side of the flow channels; the transverse turbulators projecting towards but being spaced from the cover sleeve; and (c) supplying compressor discharge air through at least some of the first and second pluralities of cooling apertures and through the flow channels to thereby cool the resilient seal.

The invention will now be described in greater detail in conjunction with the drawings identified below.

### BRIEF DESCRIPTION OF THE DRAWINGS

FIG. 1 is a partial schematic section view of a gas turbine combustor, illustrating an interface region at the aft end of a combustor liner and forward end of a transition piece;

FIG. 2 is a partial but more detailed view of the interface region of FIG. 1;

FIG. 3 is an exploded partial view of a seal construction at the aft end of a combustor liner and adapted to be engaged by the transition piece;

FIG. 4 is a schematic elevational view of an aft end of a combustor liner in accordance with an exemplary embodiment of the invention;

FIG. 5 is an end view of the combustor liner shown in FIG. 4; and

FIG. 6 is a partial perspective view of the aft end of the liner shown in FIGS. 4 and 5.

### DETAILED DESCRIPTION OF THE INVENTION

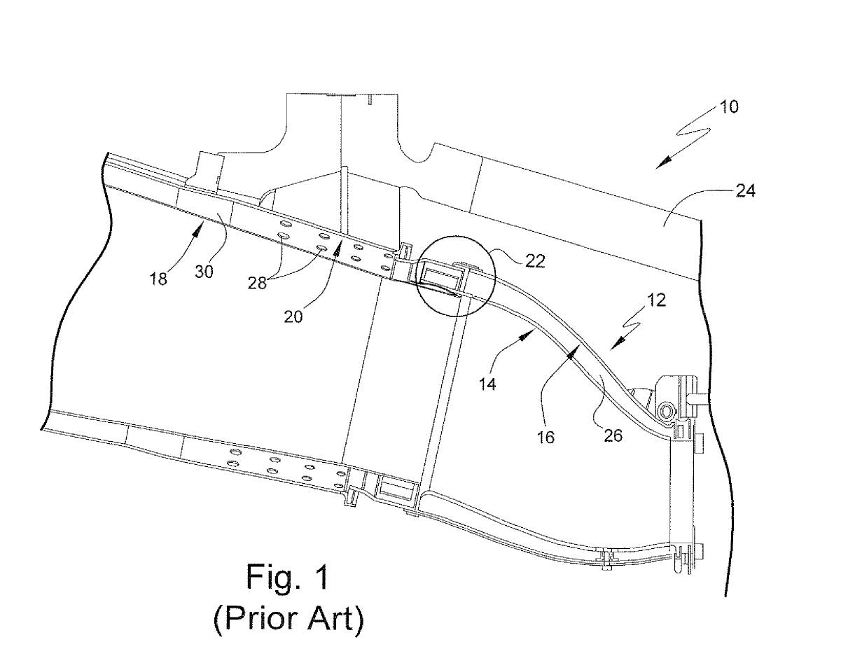

FIG. 1 schematically depicts an interface region between the aft end of a combustor liner and the forward end of a transition piece in can-annular type gas turbine combustor 10. As can be seen in this example, the transition piece 12 includes a radially inner transition piece body 14 and a radially outer transition piece impingement sleeve 16 spaced from the transition piece body 14. Upstream thereof is the combustion liner 18 and the combustor flow sleeve 20 defined in surrounding relation to the liner,

Flow from the gas turbine compressor (not shown) enters into a case 24. About 50% of the compressor discharge air passes through apertures (not shown in detail) formed along and about the transition piece impingement sleeve 16 for flow in an annular region or annulus 26 between the transition piece body 14 and the radially outer transition piece impingement sleeve 16. The remaining approximately 50% of the compressor discharge flow passes into flow sleeve holes 28 of the upstream combustion liner flow sleeve 20 and into an annulus 30 between the flow sleeve 20 and the liner 18 and eventually mixes with the air from the downstream annulus 26. The combined air eventually mixes with the gas turbine fuel in the combustion chamber.

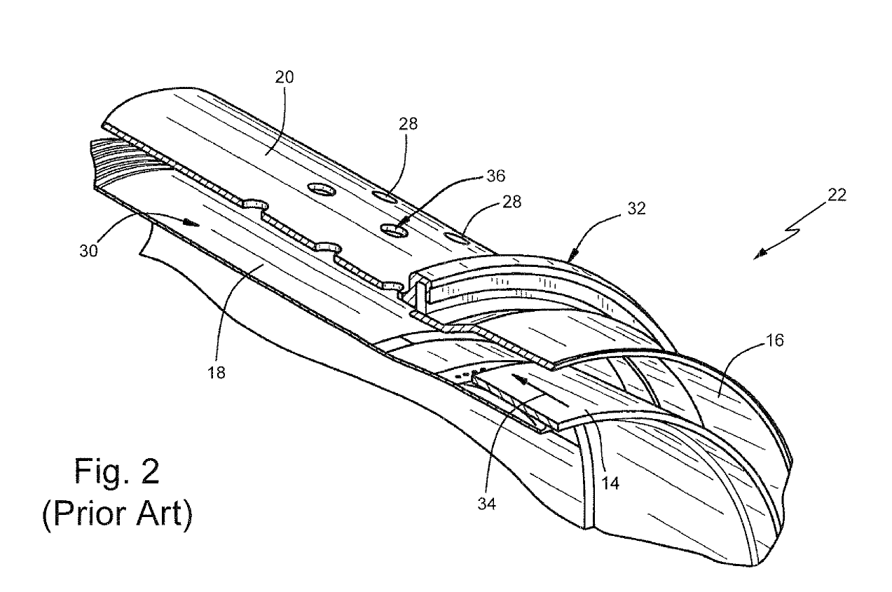

FIG. 2 illustrates in greater detail the transition region (or the connection) 22 between the transition piece/impingement sleeve 14, 16 and the combustor liner/flow sleeve 18, 20. Specifically, the impingement sleeve 16 (or second flow sleeve) of the transition piece 14 is received in telescoping relationship in a mounting flange 32 or the aft end of the combustor flow sleeve 20 (or first flow sleeve). The transition piece 14 also receives the combustor liner 18 in a telescoping relationship. The combustor flow sleeve 20 surrounds the combustor liner 18 creating flow annulus 30 (or first flow annulus) therebetween. It can be seen from the Flow arrow 34 in FIG. 2, that crossflow cooling air traveling in annulus 26 continues to flow into annulus 30 in a direction perpendicular to impingement cooling air flowing through the cooling holes 28 (see flow arrow 36) formed about the circumference of the flow sleeve 20 (while three rows are shown in FIG. 2, the flow sleeve may have any number of rows of such holes).

As previously noted, the hot gas temperature at the aft end of the liner 18, and the connection or interface region 22, is approximately 2800° F. However, the liner metal temperature at the downstream, outlet portion of interface region 22 is preferably about 1400-1550° F. As described in greater detail below, to help cool the liner 18 to this lower metal temperature range during passage of heated gases through the interface region 22, the aft end of the liner 18 has been formed with axial passages through which cooling air is flowed. This cooling air serves to draw off heat from the liner and thereby significantly lower the liner metal temperature relative to that of the hot gases.

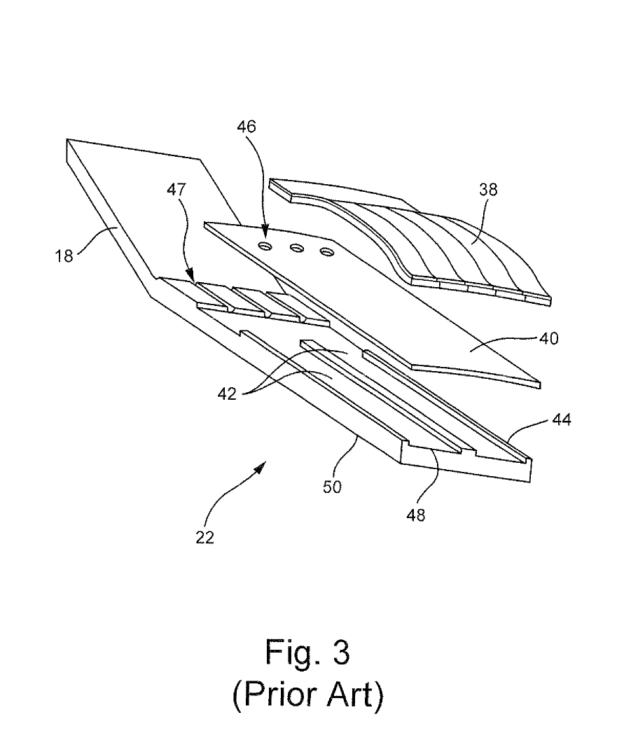

More specifically, and as best seen in FIG. 3, liner 18 has an associated compression-type seal 38, commonly referred to as a “hula seal”, mounted between an annular cover sleeve or plate 40 of the liner aft end 50, and transition piece 14. More specifically, the cover plate 40 is mounted on the liner aft end 50 to form a mounting surface for the compression seal. The liner 18 has a plurality of axial channels 42 formed by a plurality of axially extending, raised sections or ribs 44 which extend circumferentially about the aft end 50 of the liner 18. The cover sleeve 40 and ribs 44 together define the respective substantially parallel airflow channels 42, arrayed circumferentially about the aft end of the liner. Cooling air is introduced into the channels 42 through air inlet slots and/or openings 46, 47, respectively, and exits the liner through openings 48.

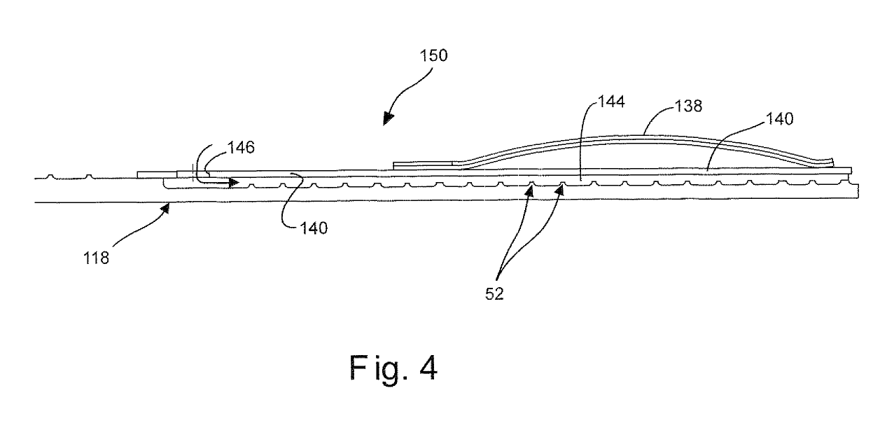

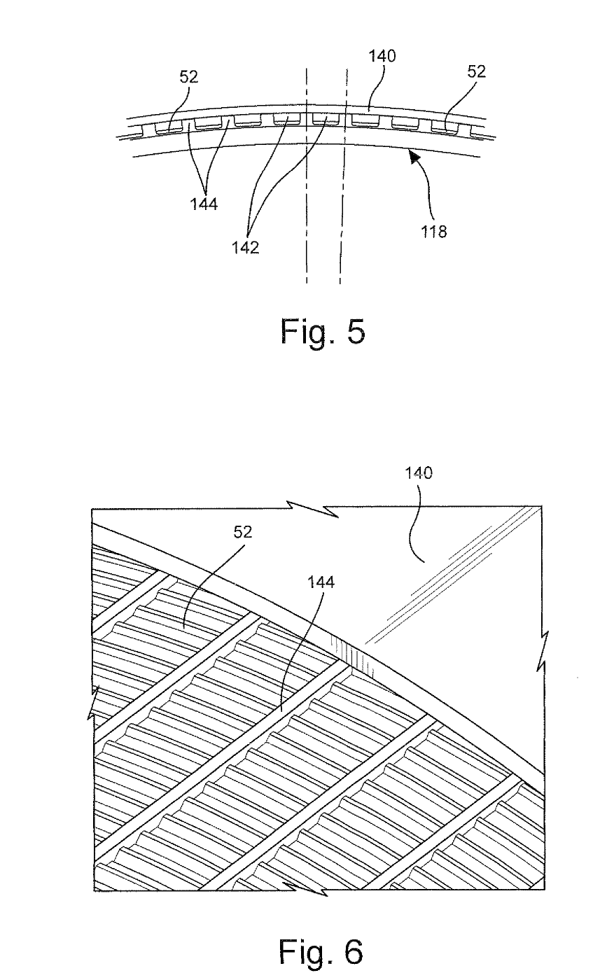

In accordance with an exemplary but nonlimiting embodiment of this invention, the cooling arrangement shown in FIG. 3 is modified to include turbulation ridges between the axially extending ribs 44. As best seen in FIGS. 4-7, where reference numerals corresponding to combustor elements shown if FIG. 3 have been retained, but with the prefix “1” added, the axially-extending ribs 144 remain, defining cooling flow channels 142, closed by the cover plate or sleeve 140. Here, however, transverse (or circumferentially-extending) turbulators 52 are introduced within each channel 142 in substantially parallel, axially spaced relationship. Note that the turbulators 52 are also in the form of ribs, but they have a height less than the height of ribs 144 so that, when the cover sleeve 140 is located about the aft end 118 of the liner, cooling air is able to flow through the channels 142, while “tripping” over the turbulators 52 and thereby increasing the local heat transfer coefficients and thereby increase cooling capability. While the turbulators 52 are shown to be generally rectilinear in shape, it will be understood that the exact height, cross-sectional shape, and axial spacing of the turbulators 52 may vary with specific applications. In addition, manufacturing techniques (machining, casting, etc.) may determine whether or not the turbulators 152 in one channel are circumferentially aligned with turbulators in the adjacent channels.

One analysis conducted to date shows temperature reductions of 50-100° F. in the interface region. Therefore, by providing the transverse turbulators 52 as proposed herein, it should be possible to achieve greater heat transfer with the same amount of cooling air (or the same amount of heat transfer with less cooling air), as compared to non-turbulated flow channels. This additional cooling capability increases service life and/or the ability to fire the gas turbine at higher temperatures and/or enables reduced NOx emissions.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A combustor liner comprising an open-ended, generally cylindrical body having a forward end and an aft end, said aft end formed with a plurality of axially extending channels defined by a plurality of axially extending, circumferentially spaced ribs; each channel provided with a plurality of axially-spaced transverse turbulators, said ribs having a height greater than said turbulators.

2. The combustor liner of claim 1, wherein said transverse turbulators are substantially parallel to each other.

3. The combustor liner of claim 1, wherein said transverse turbulators in adjacent channels are circumferentially aligned.

4. The combustor liner of claim 1, wherein said transverse turbulators are substantially rectilinear in shape.

5. The combustor liner of claim 1, wherein said flow channels are defined by axially-extending ribs formed on a radially outer surface of the combustor liner.

6. The combustor liner of claim 1 wherein said aft end is enclosed within a sleeve engaged with said ribs but not engaged with said transverse turbulators.

7. A combustor for a turbine comprising:
a combustor liner;
a first flow sleeve surrounding said combustor liner with a first flow annulus therebetween, said first flow sleeve having a plurality of cooling apertures formed about a circumference thereof for directing compressor discharge air into said first flow annulus;
a transition piece body connected to said combustor liner, said transition piece body being adapted to carry hot combustion gases to the turbine;
a second flow sleeve surrounding said transition piece body, said second flow sleeve having a second plurality of cooling apertures for directing compressor discharge air into a second flow annulus between the second flow sleeve and said transition piece body, said first flow annulus connecting to said second flow annulus;
a resilient seal structure disposed radially between an aft end portion of said combustor liner and a forward end portion of said transition piece body;
a cover sleeve disposed radially between said aft end portion of said combustor liner and said resilient seal structure, a plurality of axially-extending, circumferentially-spaced air flow channels between said cover sleeve and said aft end portion of said combustor liner; and a plurality of axially-spaced, transversely-oriented turbulators in each of said air flow channels, projecting towards but spaced from said cover sleeve.

8. The combustor of claim 7, wherein said transverse turbulators are substantially parallel to each other.

9. The combustor of claim 7, wherein said transverse turbulators in adjacent air flow channels are circumferentially aligned.

10. The combustor of claim 7, wherein said transverse turbulators are substantially rectilinear in shape.

11. The combustor of claim 7 wherein said air flow channels are defined by axially-extending ribs formed on a radially outer surface of said combustor liner.

12. A method of cooling a transition region in a gas turbine combustor between an aft end portion of a combustor liner and a forward end portion of a transition piece, said combustor liner having a first flow sleeve surrounding said combustor liner with a first flow annulus therebetween, said first flow sleeve having a first plurality of cooling apertures formed about a circumference thereof for directing compressor discharge air into said first flow annulus, said transition piece connected to said combustor liner and adapted to carry hot combustion gases to the turbine; a second flow sleeve surrounding said transition piece, said second flow sleeve having a second plurality of cooling apertures for directing compressor discharge air into a second flow annulus between the second flow sleeve and said transition piece, said first flow annulus connecting to said second flow annulus; said transition region including a resilient seal structure disposed radially between said aft end portion of said combustor liner and said forward end portion of said transition piece;
the method comprising:
(a) configuring said aft end portion of said combustor liner to include a plurality of axially-oriented flow channels, and a plurality of radially outwardly projecting, transverse turbulators in each of said flow channels;
(b) disposing a cover sleeve between said aft end portion of said combustor liner and said resilient seal structure so as to close a radially outer side of said flow channels; said transverse turbulators projecting towards but being spaced from said cover sleeve; and
(c) supplying compressor discharge air through at least some of said first and second pluralities of cooling apertures and through said flow channels to thereby cool said resilient seal.

13. The method of claim 12 wherein, in (a), the axially-oriented flow channels are formed by providing a first plurality of circumferentially-spaced, axially-extending ribs on an outer surface of said aft-end portion of said combustor liner.

14. The method of claim 13 wherein, in (a), the transverse turbulators are formed by providing a second plurality of axially-spaced, transversely-oriented ribs extending between said first plurality of circumferentially-spaced, axially-extending ribs.
